(19) United States
(12) Patent Application Publication
(10) Pub. No.: US 2013/0089046 A1
(43) Pub. Date: Apr. 11, 2013

(54) METHOD AND APPARATUS FOR DISTRIBUTED SCHEDULING FOR ENHANCING LINK PERFORMANCE IN WIRELESS COMMUNICATION SYSTEM

(71) Applicant: Samsung Electronics Co., Ltd., Suwon-si (KR)

(72) Inventors: Chi-Woo LIM, Suwon-si (KR); Shuangfeng HAN, Suwon-si (KR)

(73) Assignee: SAMSUNG ELECTRONICS CO. LTD., Suwon-si (KR)

(21) Appl. No.: 13/647,917

(22) Filed: Oct. 9, 2012

(30) Foreign Application Priority Data
Oct. 7, 2011 (KR) 10-2011-0102480

(51) Int. Cl. H04W 72/10

(52) U.S. Cl. 370/329

(57) ABSTRACT

A method for distributed scheduling in a transmission node of a wireless communication system is provided. The method includes transmitting a power signal through a first tone in a Transmission (Tx) block including tones mapped with a plurality of link identifiers, receiving a power signal from a reception node through a second tone indicating that data transmission is possible in a first Reception (Rx) block including tones mapped with a plurality of link identifiers, and receiving a power signal from the reception node through a third tone including information about a link identifier that is permissible to the reception node, in a second Rx block including tones mapped with a plurality of link identifiers.

### PRIORITY

This application claims the benefit under 35 U.S.C. §119(a) of a Korean Patent Application filed on Oct. 7, 2011 in the Korean Intellectual Property Office and assigned Serial No. 10-2011-0102480, the entire disclosure of which is hereby incorporated by reference.

### BACKGROUND OF THE INVENTION

1. Field of the Invention

The present invention relates to wireless communication. More particularly, the present invention relates to a method and apparatus for distributed scheduling in a communication system.

2. Description of the Related Art

Device-to-Device (D2D) communication is expected to be an important feature supported in next-generation cellular networks. D2D communication makes the cellular-system based structure unnecessary, and has various merits including a decrease in battery consumption, transmission rate increases, decreases in infrastructure failure, and new service features. In addition, with the spreading of a data services and smart phones (e.g., the iPhone), attention is again being paid to the concept of an ad-hoc wireless network. An ad-hoc wireless network could guarantee scalability and improved performance using less spectrum resources. The network modeling and algorithm community has done new research into cross-layer synchronization resource allocation mechanisms that show a theoretical gain. However, because of the belief that messaging (i.e., messaging for channel-state aware spatial coordination) and synchronization overhead make a synchronous cross-layer scheme difficult, such wireless or ad-hoc network realization and deployments mostly focus on asynchronous Carrier Sense Multiple Access/Collision Avoidance (CSMA/CA) mechanisms and change.

Distributed scheduling in wireless networks has attracted the attention of many researchers in the field over the last several years. Attention has focused on the potential throughput loss caused by a maximal matching distributed scheduling algorithm as compared to a centralized scheduling algorithm, along with various ways to improve maximal matching. Many of these schemes are based on combinatorial interference models at the physical layer and focus on how to schedule links given the feasible independent sets, i.e., links are allowed to transmit simultaneously based on the combinatorial interference model. However, technical issues surrounding these feasible independent sets based on actual Signal-to-Interference Ratios (SIRs) with fading channels (channel coefficients could change on a per-time-slot basis), taking into account the additional inclusion of multiple power levels and rates, are often not adequately addressed.

Separately, there exists a scenario in which many devices coexist in an area, and some of those devices desire to directly communicate with the other devices. Because a D2D communication system does not have a centralized controller (e.g., a Base Station (BS)) adjusting the communication of a terminal, D2D systems need a method for designing a distributed scheduling scheme that supports a maximum number of generated communication links.

Accordingly, there is a need to provide a distributed scheduling technique for supporting a maximum number of links simultaneously generated, despite having interference between the permissible links.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages below. Accordingly, an aspect of the present invention is to provide a method and apparatus for communication in a Device-to-Device (D2D) communication system.

Another aspect of the present invention is to provide a method and apparatus for distributed scheduling in a D2D communication system.

A further aspect of the present invention is to provide a method and apparatus for setting the maximum number of links in a D2D communication system.

The above aspects are addressed by providing a method and apparatus for distributed scheduling in order to enhancing link performance in a wireless communication system.

According to an aspect of the present invention, a method for distributed scheduling in a transmission node of a wireless communication system is provided. The method includes transmitting a power signal through a first tone in a Transmission (Tx) block including tones mapped with a plurality of link identifiers, receiving a power signal from a reception node through a second tone indicating that data transmission is possible in a first Reception (Rx) block including tones mapped with a plurality of link identifiers, and receiving a power signal from the reception node through a third tone including information about a link identifier that is permissible to the reception node in a second Rx block including tones mapped with a plurality of link identifiers. The power signal received through the second tone indicates that a Signal to Interference Noise Ratio (SINR) is satisfied in the reception node. The power signal received through the third tone indicates the number of link identifiers of low priority that is permissible to the reception node.

According to another aspect of the present invention, a method for distributed scheduling in a reception node of a wireless communication system is provided. The method includes receiving power signals of a plurality of transmission nodes through a plurality of tones in a Tx block including tones mapped with a plurality of link identifiers, transmitting a power signal to a corresponding transmission node through a first tone indicating that data transmission with the corresponding transmission node is possible in a first Rx block including tones mapped with a plurality of link identifiers, and transmitting a power signal to a corresponding transmission node through a second tone including information about a link identifier that is permissible to the reception node in a second Rx block including tones mapped with a plurality of link identifiers. The power signal transmitted through the first tone indicates that a SINR is satisfied in the reception node. The power signal transmitted through the second tone indicates the number of link identifiers of low priority that is permissible to the reception node.

According to a further aspect of the present invention, an apparatus for distributed scheduling in a transmission node of a wireless communication system is provided. The apparatus includes a scheduler for transmitting a power signal through a first tone in a Tx block including tones mapped with a plurality of link identifiers, receiving a power signal from a reception node through a second tone indicating that data transmission is possible in a first Rx block including tones mapped with a plurality of link identifiers, and receiving a power signal from the reception node through a third tone including information about a link identifier that is permissible to the reception node in a second Rx block including tones mapped with a plurality of link identifiers. The power signal received through the second tone indicates that a SINR is satisfied in the reception node. The power signal received through the third tone indicates the number of link identifiers of low priority that is permissible to the reception node.

In the exemplary embodiment of the present invention, the scheduler determines the number of link identifiers of low priority that is permissible to the reception node based on a power level of the reception node received through the third tone.

In the exemplary embodiment of the present invention, when the number of link identifiers of low priority that is permissible to the reception node is greater than ‘1’, a level of the power signal received through the third tone increases by more than a level of the power signal received through the second tone.

In the exemplary embodiment of the present invention, when the power signal is transmitted at maximum output in the first Rx block, the power level in the second Rx block is determined as a difference between the maximum output and an output corresponding to the number of link identifiers of low priority that is permissible to the reception node.

In the exemplary embodiment of the present invention, the first tone of the Tx block and the second tone of the first Rx block are connected as one pair and have priority.

In the exemplary embodiment of the present invention, wherein the Tx block, the first Rx block, and the second Rx block are comprised in one traffic slot, a plurality of traffic slots constructs one priority hold period, and during the one priority hold period, link priority is not changed.

According to yet another aspect of the present invention, an apparatus for distributed scheduling in a reception node of a wireless communication system is provided. The apparatus includes a scheduler for receiving power signals of a plurality of transmission nodes through a plurality of tones in a Tx block including tones mapped with a plurality of link identifiers, transmitting a power signal to a corresponding transmission node through a first tone indicating that data transmission with the corresponding transmission node is possible in a first Rx block including tones mapped with a plurality of link identifiers, and transmitting a power signal to a corresponding transmission node through a second tone including information about a link identifier that is permissible to the reception node in a second Rx block including tones mapped with a plurality of link identifiers. The power signal transmitted through the first tone indicates that a SINR is satisfied in the reception node. The power signal transmitted through the second tone indicates the number of link identifiers of low priority that is permissible to the reception node.

In the exemplary embodiment of the present invention, the scheduler determines the number of link identifiers of low priority that is permissible to the reception node.

In the exemplary embodiment of the present invention, when the number of link identifiers of low priority that is permissible to the reception node is greater than ‘1’, a level of the power signal transmitted through the second tone increases more than a level of the power signal transmitted through the first tone.

In the exemplary embodiment of the present invention, when a power signal is transmitted at maximum output in the first Rx block the power level in the second Rx block is determined as a difference between the maximum output and the number of link identifiers of low priority that is permissible to the reception node.

In the exemplary embodiment of the present invention, one tone of the Tx block and one tone of the first Rx block are connected as one pair and have priority.

In the exemplary embodiment of the present invention, the Tx block, the first Rx block, and the second Rx block are comprised in one traffic slot, a plurality of traffic slots constructs one priority hold period, and during the one priority hold period, link priority is not changed.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of the present invention will become more apparent from the following description taken in conjunction with the accompanying drawings in which:

FIGS. 1A and 1B are diagrams illustrating a frame structure for Device-to-Device (D2D) communication according to exemplary embodiments of the present invention;

FIG. 2 is a diagram illustrating a detailed traffic slot according to an exemplary embodiment of the present invention;

FIG. 3 is a diagram illustrating a structure of a transmission (Tx) block, a first reception (Rx) block, and a second Rx block for performing connection scheduling according to an exemplary embodiment of the present invention;

FIG. 4 is a flowchart illustrating a procedure of D2D communication according to an exemplary embodiment of the present invention;

FIG. 5 is a flowchart illustrating an operation of a transmission node according to an exemplary embodiment of the present invention; and

FIG. 6 is a flowchart illustrating an operation of a reception node according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is to be understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

The present invention describes a method and apparatus for distributed scheduling for improving link performance in a Device-to-Device (D2D) communication system.

Hereinafter, exemplary embodiments of the invention are described in detail with reference to the accompanying drawings.

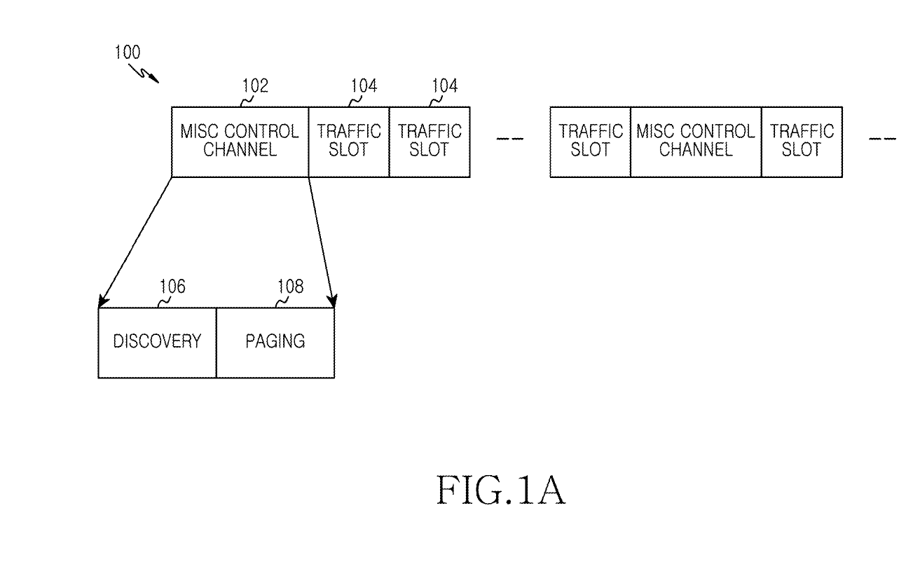

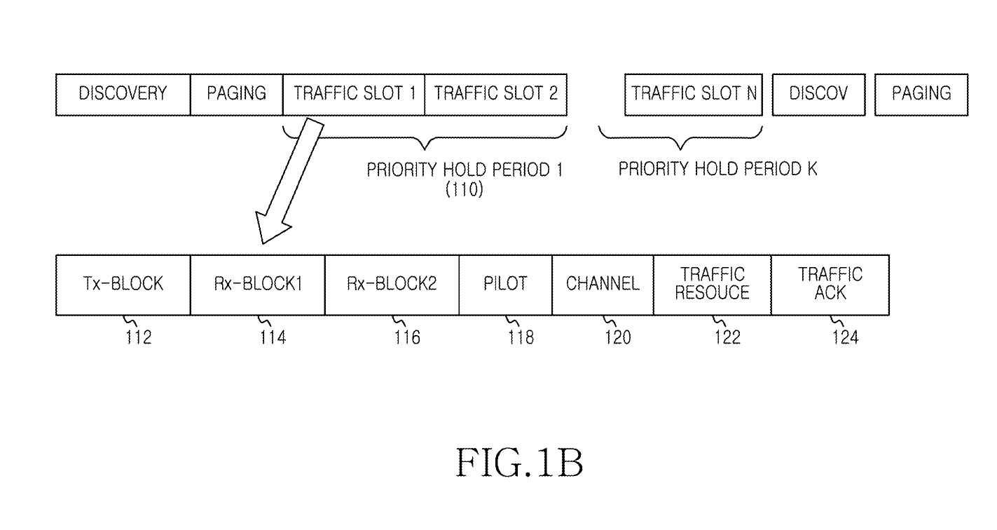

FIGS. 1A and 1B illustrate a frame structure for D2D communication according to an exemplary embodiment of the present invention.

Referring to FIG. 1A, the frame structure 100 is divided into a control channel 102 and a plurality of traffic slots 104. The control channel is divided into a discovery slot 106 and a paging slot 108.

The discovery slot may be used for performing a peer device discovery procedure in which each device discovers a peer device. For example, the peer device discovery procedure can allow nodes to transmit information notifying other nodes of their existence, and detect the existence of other nodes.

The paging slot may be used for performing a paging procedure in which a potential transmission node transmits signaling to a reception node for future communication.

Referring to FIG. 1B, after the paging procedure, a regular communication period including the plurality of traffic slots starts. In each traffic slot, potential transmission/reception nodes are scheduled and thereafter, data transmission follows. Here, the plurality of traffic slots has at least one or more Priority Hold Periods (PHPs) 110.

The traffic slot may be divided into a Transmission (Tx) block 112, a first Reception (Rx) block 114, a second Rx block 116, a pilot resource 118, a channel feedback resource 120, a traffic resource 122, and a traffic Acknowledgement (Ack) resource 124.

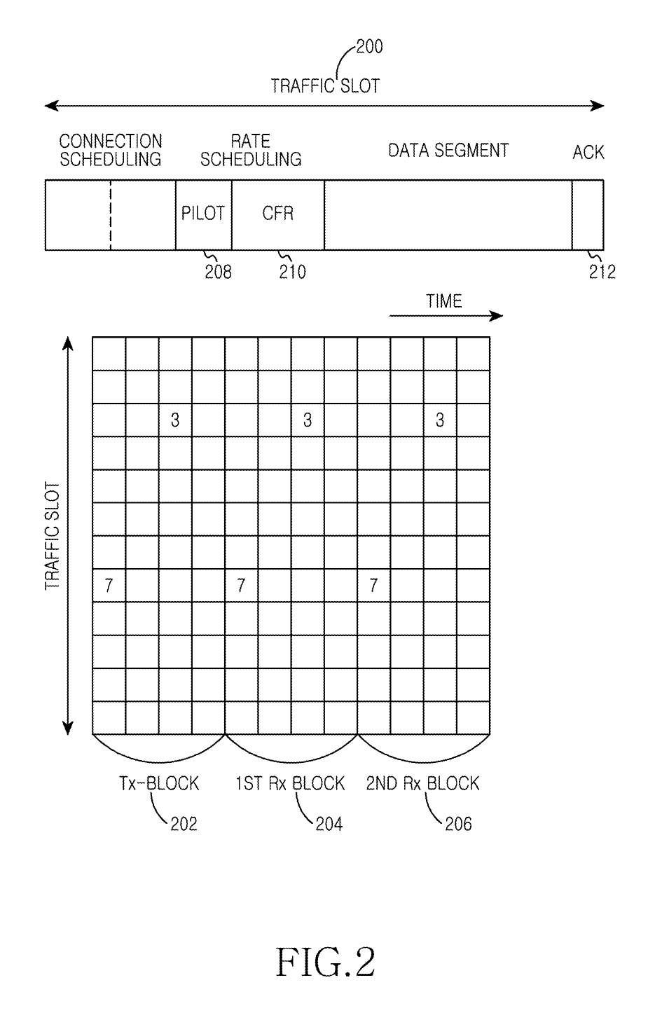

FIG. 2 illustrates a detailed traffic slot according to an exemplary embodiment of the present invention.

Referring to FIG. 2, a Tx block 202, a first Rx block 204, and a second Rx block 206 within a traffic slot 200 perform connection scheduling. A pilot resource 208 and a channel feedback resource 210 within the traffic slot perform rate scheduling. A traffic resource within the traffic slot performs traffic transmission through a corresponding link. A traffic Ack 212 resource within the traffic slot performs signaling for successful packet reception.

After the paging procedure, one priority related to each link IDentifier (ID) in a potential communication link exists. The priority may be constructed semi-statically. For example, a plurality of traffic slots may be grouped into one priority hold period. For example, every ten traffic slots have one PHP. In each PHP, one priority may be created for each link identifier, and may not change over the whole period of the PHP. In a next PHP, new priority will be created independently of a previous PHP.

A communication system of an exemplary embodiment of the present invention uses an Orthogonal Frequency Division Multiplexing (OFDM) scheme. After link scheduling, a scheduled communication pair performs communication based on all available bands. A multiple access mode is spatial domain multiplexing. For this reason, it may be very important to design an efficient distributed scheduling algorithm to maximize a system throughput.

The proposed distributed scheduling scheme may be applied to each traffic slot of each PHP.

In each traffic slot, three scheduling blocks located just after the paging procedure are designed. Each block uses a specific time/frequency resource, and represents an ‘M’ symbol and an ‘N’ subcarrier for each block. In each block, each link identifier may be mapped with one tone resource (i.e., symbol/subcarrier). The link identifier may also be called a connection ID.

For instance, in FIG. 2, link 3 and link 7 have been scheduled. In each of a Tx block and a first Rx block, one tone is connected as one pair and has priority. The priority may be higher as it goes left and up. The priority may be lower as it goes right and down. The links can be fixedly arranged according to a random priority list. However, a reference determining priority in exemplary embodiments of the present invention is not limited, and can be determined in various ways.

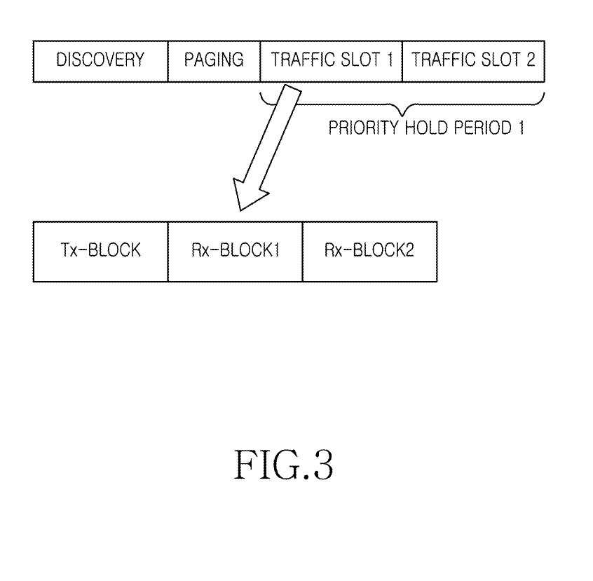

FIG. 3 illustrates a structure of a Tx block, a first Rx block, and a second Rx block for performing connection scheduling according to an exemplary embodiment of the present invention.

Referring to FIG. 3, the Tx block is used for requesting link scheduling. In the first time slot within each PHP, one priority is allocated to each link identifier mapped with other time/frequency resources. The priority may be held during one PHP. Transmission nodes perform transmission at required power levels through their subcarriers, whereby each reception node can estimate interference from each of the transmission nodes. Because the transmission signal may be transmitted through other resources, each reception node can detect a signal, which includes an expected signal power of the transmission signal and an interference power from other transmission nodes.

When a potential transmission node requests link scheduling through the Tx block, the Rx block may be used as a response to this.

There may be two Rx blocks following the Tx block. Each reception node following the Tx block may be aware of which transmission nodes have low priority that are not permitted for transmission in order to guarantee a specific Signal to Interference Noise Ratio (SINR) level. If the transmission nodes having low priority cause too much interference in a transmission node having high priority, the transmission nodes having low priority are not permitted to perform transmission. If a reception SINR of one reception node is lower than an arbitrary threshold, the reception node may determine not to receive the transmission of the transmission node, and may notify its determination to the transmission node. For example, a reception node may notify the transmission node of transmission or non-transmission by not transmitting a power signal through a tone corresponding to a corresponding link of the Rx block. During peer device discovery and paging procedures a transmit power of each communication link may be determined as a transmit power for future data communication. Accordingly, if the reception SINR is very low, the reception node may be aware that, although the transmission node may increase its power, its resultant reception SINR may not be satisfied.

Rx-block 1: Each reception node can determine a SINR because each is aware of interference from all transmission nodes. Based on a SINR threshold in each reception node, the reception nodes determine the number of permissible link identifiers having low priority, or the total number thereof. In operation, priority_2 link may cause too much interference for priority_1 link based on priority. Each reception node transmits a power signal indicating the number of its permissible link identifiers of low priority and, accordingly, each transmission node may determine which transmission nodes are permitted by the reception nodes.

In the Rx block 1, if a SINR of a reception node having priority ‘L’ is sufficient, it may be assumed that links from priority of ‘1’ higher than priority ‘L’ to priority ‘L−1’ are scheduled. For example, such is defined as in Equation 1 below.

$${SINR}_{L} = \frac{{P}_{L}}{{\sum }_{i = 1}^{L - 1} {P}_{i} + N} > {TH}_{SINR} \qquad ( 1 )$$

Here, the ‘SINR_{L}’ is a SINR value in the reception node having the priority ‘L’, the ‘N’ is a noise, and the ‘Pi’ represents power received from an ith transmission node.

After that, the reception node having the priority ‘L’ determines if link identifiers of a priority lower than the priority ‘L’ are permissible. The number (NL) (L=1, . . . , N, N: maximum number of supportable link identifiers) of link identifiers of a priority lower than the priority ‘L’ of the reception node is determined as in Equation 2 below.

$${SINR}_{L} = \frac{{P}_{L}}{{\sum }_{i = 1}^{L - 1} {P}_{i} + {\sum }_{i = L + 1}^{L + 1 + {N}_{L}} {P}_{i} + N} < {TH}_{SINR} \\ {SINR}_{L} = \frac{{P}_{L}}{{\sum }_{i = 1}^{L - 1} {P}_{i} + {\sum }_{i = L + 1}^{L + {N}_{L}} {P}_{i} + N} > {TH}_{SINR} \qquad ( 2 )$$

The reception nodes transmit a direct power signal at the same power as the Tx block or at the maximum power. In an exemplary embodiment, reception nodes having reception SINRs lower than a threshold do not perform transmission.

Rx-block 2: In the Rx-block 2, reception nodes transmit a direct power signal to transmission nodes to indicate a number of permissible link identifiers of low priority, or the total number (N_{L}) thereof. In an exemplary embodiment, if the number of the permissible link identifiers of low priority, or the total number (N_{L}) thereof is very high, the reception nodes perform transmission based on a mapping rule. For example, fed back real numbers of link identifiers of low priority, or the total number (N_{L}*) thereof, can be inferred as in N_{L}*=x log N_{L}. Here, the ‘x’ is a constant value known to all devices.

In the Rx-block 2, a power level for a reception node having priority is inferred as in Equation 3 below.

P_{L,rx-block2}=P_{L,rx-block1}+N_{L}* (3)

That is, if the numbers of the permissible link identifiers of the low priority or the number thereof is greater than ‘1’, the transmission node receives higher power.

If the maximum output is transmitted to the first Rx block, P_{L,rx-block1}=Pₘₐₓ is given. In an exemplary embodiment, the reception node decreases a transmit power in the Rx-block 2 as in Equation 4 below.

P_{L,rx-block2}=Pₘₐₓ−N_{L}* (4)

In a kth scheduling slot of each PHP, transmission nodes permitted for transmission perform the transmission in a (k−1)th scheduling slot. Transmission nodes not permitted by reception nodes having higher priority may not perform transmission in the (k−1)th scheduling slot. Transmission nodes determined for the reception node to yield (Rx yielding) to data transmission in the (k−1)th scheduling slot. This design may be advantageous in a case of, for example, the first traffic slot of each PHP, because of a low SINR resulting from the interference signal power expected from link identifiers of higher priority, which some reception nodes not to receive. However, after scheduling in each traffic slot, some transmission nodes of higher priority do not perform transmission in a related traffic slot. This denotes that reception nodes of low priority are able to still receive their signals of permissible SINR. In a proposed scheme, a PHP may be designed. Within each PHP, for example, after a traffic slot, more communication links may be made possible. During a next PHP, new priority may be created and, excepting different priority of each link identifier, scheduling may be the same as the above.

According to another exemplary embodiment of the present invention, a first Rx block and a second Rx block may correspond on a point-to-point basis, and transmit, instead of the number of permissible link identifiers of low priority, a tone corresponding to a link identifier to transmit the link identifier.

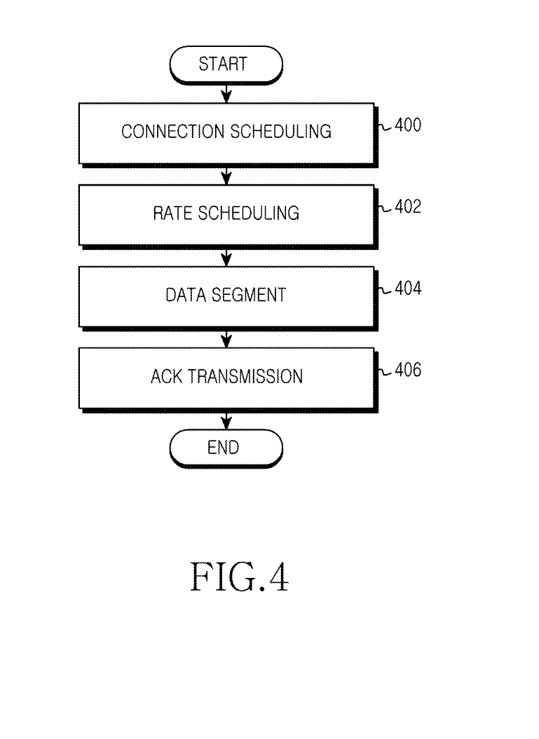

FIG. 4 is a flowchart illustrating D2D communication according to an exemplary embodiment of the present invention.

Referring to FIG. 4, in step 400, devices perform connection scheduling. For example, potential transmission nodes each perform a scheduling request through one tone allocated within a Tx block. The scheduling request may be a direct power signal. Potential reception nodes listen to the Tx block and determine whether to permit data transmission through a corresponding link.

If the reception node does not permit data communication through the corresponding link (hereinafter, referred to as ‘Rx-yielding’), the reception node does not respond. That is, the reception node does not transmit a power signal through a tone allocated within a first Rx block.

If the reception node does not select Rx-yielding, the reception node transmits the power signal through the tone allocated within the first Rx block and, based on the number of permissible link identifiers of low priority, the reception node determines the power of a second Rx block and transmits a power signal through an allocated tone.

In step 402, the devices perform rate scheduling for transmission nodes scheduled to be transmitted within a slot of connection scheduling. For example, in step 402, the devices determine a coding rate and modulation scheme for a corresponding link based on a pilot channel and a feedback channel.

In step 404, the devices perform data segmentation for data to be transmitted through a scheduled link.

In step 406, the devices use an Ack slot for signaling successful packet reception based on a link identifier.

Next, the devices terminate the procedure.

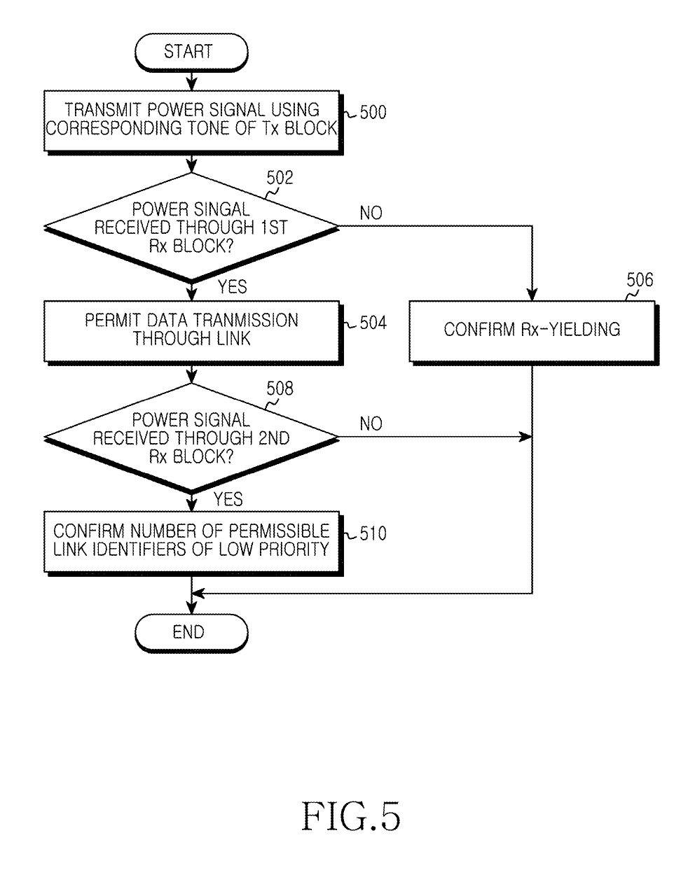

FIG. 5 is a flowchart illustrating an operation of a transmission node according to an exemplary embodiment of the present invention.

Referring to FIG. 5, in step 500, potential transmission nodes each transmit a power signal based on a corresponding tone of a Tx block to make a request for scheduling.

Thereafter, in step 502, the potential transmission nodes each determine if a power signal is received through a tone of a first Rx block mapped with a tone of a corresponding Tx block.

Although not illustrated, in step 502, the transmission node listens to the power signal through all tones of the first Rx block and determines whether to Tx-yield. For example, the transmission node determines whether to perform transmission to satisfy a reception SINR in a reception node of high priority.

When the power signal is received through the tone of the first Rx block mapped with the tone of the corresponding Tx block, in step 504, the transmission node permits data transmission through a link.

In contrast, when the power signal is not received through the tone of the first Rx block mapped with the tone of the corresponding Tx block, in step 506, the transmission node recognizes Rx-yielding as not satisfying the reception SINR in the reception node.

In step 508, the transmission node receives a power signal indicating the number of permissible link identifiers of low priority through the second Rx block.

In the second Rx block, a power level for a reception node having priority ‘L’ is inferred by Equation 3 above. That is, if numbers of permissible link identifiers of low priority, or the total number thereof, is greater than ‘1’, the transmission node receives higher power through the second Rx block. If the maximum output is transmitted to the first Rx block, the reception node decreases transmit power in the Rx-block 2 as in Equation 4 above.

Thereafter, in step 510, the transmission node confirms the number of permissible link identifiers of low priority based on a power level of the second Rx block.

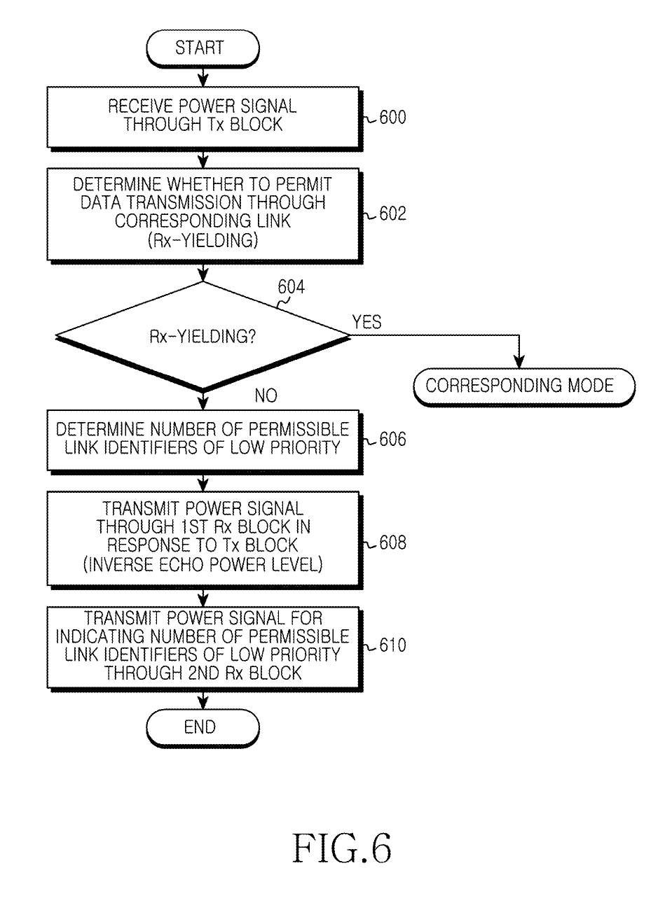

FIG. 6 is a flowchart illustrating an operation of a reception node according to an exemplary embodiment of the present invention.

Referring to FIG. 6, in step 600, the reception node receives a power signal through a Tx block from all transmission nodes.

Next, in step 602, the reception node determines whether to permit data transmission through a corresponding link (hereinafter, referred to as ‘Rx-yielding’). For example, the reception node determines if it satisfies a reception SINR based on a link identifier having priority higher than itself, as in Equation 1 above.

Thereafter, in step 604, the reception node determines if there is a need to perform Rx-yielding. When it is determined in step 604 that there is a need to perform Rx-yielding (i.e., when not satisfying the reception SINR), the reception node proceeds to a corresponding mode. For example, in the corresponding mode, the reception node does not respond to the Tx block. In other words, the reception node does not transmit a power signal to a transmission node through a first Rx block.

When it is determined in step 604 that there is no need to perform the Rx-yielding (that is, when satisfying the reception SINR), the reception node proceeds to step 606 and determines the number of permissible link identifiers of low priority or numbers thereof based on Equation 2 above.

Next, in step 608, the reception node transmits a power signal through the first Rx block in response to the Tx block (inverse echo power level). For example, the reception node notifies the transmission node that it satisfies the reception SINR.

Thereafter, in step 610, the reception node transmits a power signal for indicating the number of permissible link identifiers of low priority or numbers thereof, through a second Rx block. For example, the reception node notifies the number of permissible link identifiers of low priority, or the total number thereof, of the transmission node through the second Rx block.

In the second Rx block, a power level for a reception node having priority ‘L’ is inferred by Equation 3 above. For example, if the numbers of permissible link identifiers of low priority, or the total number thereof is greater than ‘1’, the transmission node receives higher power through the second Rx-block. If the maximum output is transmitted to the first Rx-block, the reception node decreases transmit power in the Rx-block 2 as in Equation 4 above.

Next, the reception node terminates the procedure.

As described above, there may be an advantage in that, by defining a second Rx-block as indicating whether a link connection having a priority lower than itself is permissible, a reception node connects the maximum number of links in distributed scheduling. In addition, the reception node guarantees SINR limitation in a link of high priority in Tx-yielding based on a threshold. Further, the reception node may prevent an unnecessary increase in the total number of links.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for distributed scheduling in a transmission node of a wireless communication system, the method comprising:
transmitting a power signal through a first tone in a Transmission (Tx) block comprising tones mapped with a plurality of link identifiers;
receiving a power signal from a reception node through a second tone indicating that data transmission is possible, in a first Reception (Rx) block comprising tones mapped with a plurality of link identifiers; and
receiving a power signal from the reception node through a third tone comprising information about a link identifier that is permissible to the reception node, in a second Rx block comprising tones mapped with a plurality of link identifiers,
wherein the power signal received through the second tone indicates that a Signal to Interference Noise Ratio (SINR) is satisfied in the reception node, and
wherein the power signal received through the third tone indicates the number of link identifiers of low priority that is permissible to the reception node.

2. The method of claim 1, further comprising determining the number of link identifiers of low priority that is permissible to the reception node based on the power level of the reception node received through the third tone.

3. The method of claim 1, wherein, when the number of link identifiers of low priority that is permissible to the reception node is greater than ‘1’, a level of the power signal received through the third tone increases by more than a level of the power signal received through the second tone.

4. The method of claim 1, wherein, when the power signal is transmitted at maximum output in the first Rx block, the power level in the second Rx block is determined as a difference between the maximum output and an output corresponding to the number of link identifiers of low priority that is permissible to the reception node.

5. The method of claim 1, wherein the first tone of the Tx block and the second tone of the first Rx block are connected as one pair and have priority.

6. The method of claim 1, wherein the Tx block, the first Rx block, and the second Rx block are comprised in one traffic slot,
wherein a plurality of traffic slots constructs one priority hold period, and
wherein, during the one priority hold period, link priority is not changed.

7. A method for distributed scheduling in a reception node of a wireless communication system, the method comprising:
receiving power signals of a plurality of transmission nodes through a plurality of tones in a Transmission (Tx) block comprising tones mapped with a plurality of link identifiers;
transmitting a power signal to a corresponding transmission node through a first tone indicating that data transmission with the corresponding transmission node is possible in a first Reception (Rx) block comprising tones mapped with a plurality of link identifiers; and
transmitting a power signal to a corresponding transmission node through a second tone comprising information about a link identifier permissible to the reception node in a second Rx block comprising tones mapped with a plurality of link identifiers,
wherein the power signal transmitted through the first tone indicates that a Signal to Interference and Noise Ratio (SINR) is satisfied in the reception node, and
wherein the power signal transmitted through the second tone indicates the number of link identifiers of low priority that is permissible to the reception node.

8. The method of claim 7, further comprising determining the number of link identifiers of low priority that is permissible to the reception node.

9. The method of claim 7, wherein, when the number of link identifiers of low priority that is permissible to the reception node is greater than ‘1’, a level of the power signal transmitted through the second tone increases more than a level of the power signal transmitted through the first tone.

10. The method of claim 7, wherein, when a power signal is transmitted at maximum output in the first Rx block, the power level in the second Rx block is determined as a difference between the maximum output and the number of link identifiers of low priority that is permissible to the reception node.

11. The method of claim 7, wherein one tone of the Tx block and one tone of the first Rx block are connected as one pair and have priority.

12. The method of claim 7, wherein the Tx block, the first Rx block, and the second Rx block are comprised in one traffic slot,
wherein a plurality of traffic slots constructs one priority hold period, and
wherein, during the one priority hold period, link priority is not changed.

13. An apparatus for distributed scheduling in a transmission node of a wireless communication system, the apparatus comprising:
a scheduler for transmitting a power signal through a first tone in a Transmission (Tx) block comprising tones mapped with a plurality of link identifiers;
receiving a power signal from a reception node through a second tone indicating that data transmission is possible in a first Reception (Rx) block comprising tones mapped with a plurality of link identifiers; and
receiving a power signal from the reception node through a third tone comprising information about a link identifier that is permissible to the reception node in a second Rx block comprising tones mapped with a plurality of link identifiers,
wherein the power signal received through the second tone indicates that a Signal to Interference Noise Ratio (SINR) is satisfied in the reception node, and
wherein the power signal received through the third tone indicates the number of link identifiers of low priority that is permissible to the reception node.

14. The apparatus of claim 13, wherein the scheduler determines the number of link identifiers of low priority that is permissible to the reception node based on a power level of the reception node received through the third tone.

15. The apparatus of claim 13, wherein, when the number of link identifiers of low priority that is permissible to the reception node is greater than ‘1’, a level of the power signal received through the third tone increases by more than a level of the power signal received through the second tone.

16. The apparatus of claim 13, wherein, when the power signal is transmitted at maximum output in the first Rx block, the power level in the second Rx block is determined as a difference between the maximum output and an output corresponding to the number of link identifiers of low priority that is permissible to the reception node.

17. The apparatus of claim 13, wherein the first tone of the Tx block and the second tone of the first Rx block are connected as one pair and have priority.

18. The apparatus of claim 13, wherein the Tx block, the first Rx block, and the second Rx block are comprised in one traffic slot,
wherein a plurality of traffic slots constructs one priority hold period, and
wherein, during the one priority hold period, link priority is not changed.

19. An apparatus for distributed scheduling in a reception node of a wireless communication system, the apparatus comprising:
a scheduler for receiving power signals of a plurality of transmission nodes through a plurality of tones in a Transmission (Tx) block comprising tones mapped with a plurality of link identifiers;
transmitting a power signal to a corresponding transmission node through a first tone indicating that data transmission with the corresponding transmission node is possible in a first Reception (Rx) block comprising tones mapped with a plurality of link identifiers; and
transmitting a power signal to a corresponding transmission node through a second tone comprising information about a link identifier permissible to the reception node in a second Rx block comprising tones mapped with a plurality of link identifiers,
wherein the power signal transmitted through the first tone indicates that a Signal to Interference and Noise Ratio (SINR) is satisfied in the reception node, and
wherein the power signal transmitted through the second tone indicates the number of link identifiers of low priority that is permissible to the reception node.

20. The apparatus of claim 19, wherein the scheduler determines the number of link identifiers of low priority that is permissible to the reception node.

21. The apparatus of claim 19, wherein, when the number of link identifiers of low priority that is permissible to the reception node is greater than ‘1’, a level of the power signal transmitted through the second tone increases more than a level of the power signal transmitted through the first tone.

22. The apparatus of claim 19, wherein, when a power signal is transmitted at maximum output in the first Rx block the power level in the second Rx block is determined as a difference between the maximum output and the number of link identifiers of low priority that is permissible to the reception node.

23. The apparatus of claim 19, wherein one tone of the Tx block and one tone of the first Rx block are connected as one pair and have priority.

24. The apparatus of claim 19, wherein the Tx block, the first Rx block, and the second Rx block are comprised in one traffic slot,
wherein a plurality of traffic slots constructs one priority hold period, and
wherein, during the one priority hold period, link priority is not changed.
